(19) United States
(12) Patent Application Publication
(10) Pub. No.: US 2010/0052477 A1
(43) Pub. Date: Mar. 4, 2010

(54) LARGE STROKE PIEZO ACTUATOR

(75) Inventors: Andrew T. Johnson, Scottsdale, AZ (US); Casey Hanlon, Queen Creek, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/201,607

(22) Filed: Aug. 29, 2008

(51) Int. Cl. H02N 2/04

(52) U.S. Cl. 310/328

(57) ABSTRACT

An actuator device configured to provide a large stroke output. The actuator device including a first piezo element and a second piezo element disposed within a housing. The first piezo element and the second piezo element having a combined long dimension and a height, wherein the long dimension is greater than the height. A fluid region containing a hydraulic fluid is defined in the piezo actuator element at a mid-point of the long dimension and extending parallel with the height of the piezo actuator element. An amplifier including a piston element is slidably coupled to the fluid region. The amplifier provides a large stroke output of the piston element at a mid-point of the long dimension of the piezo actuator elements in response to displacement of the fluid within the fluid region when under the influence of an applied voltage.

### TECHNICAL FIELD

The present invention generally relates to actuators, and more particularly relates to a large stroke piezo actuator and packaging of the actuator.

### BACKGROUND

Capacitive devices, such as piezoceramic actuators exhibit many desirable mechanical and electrical characteristics. A piezo actuator is a spring-and-mass system that provides efficient coupling of energy from applied charge to mechanical strain, resulting in a high bandwidth, a large force output and negligible resistive heating. The actuator stiffness is typically determined by the modulus of the ceramic material used for the actuator, rather than by an inherently weak magnetic coupling commonly found in other types of inductive actuators. To protect the piezoceramic against destructive external conditions, they are often provided with a metal casing and an integrated preload spring to absorb tensile forces. Piezoceramic actuators have historically been limited to extremely low displacement applications where precision is of utmost importance. Some of these applications include, but are not limited to ink jet nozzles, ultrasonic medical devices and miniature valves, where small stroke motions of only a few thousandths of an inch are needed.

One type of known piezoceramic actuator includes electrically actuated elements that change dimension by expanding and contracting in response to an applied electrical drive signal to displace fluid. The displaced fluid in turn drives a hydraulic ram. Classic piezoceramic actuation in these types of devices is very short or small on stroke output. In addition, the output is at an end of the device. Previous attempts to alleviate this problem include the use of mechanical amplifiers. Although this type of amplification is able to amplify the stroke output, it is only able to modify the stroke ratios equating to minimal application. Modifications to the stroke orientation and overall packaging of the piezo actuator are needed to provide for a device capable of a larger stroke output, thereby increasing performance, while maintaining a small package or envelope.

It should thus be appreciated from the above that it would be desirable to provide an improved piezo actuator capable of providing enhanced performance in a small package. Therefore, there is a need for a means for providing stroke amplification that provides for a larger stroke output while maintaining a small overall package design. Furthermore, other desirable features and characteristics of the present invention will become apparent from the subsequent detailed description of the invention and the appended claims, taken in conjunction with the accompanying drawings and this background of the invention.

### BRIEF SUMMARY

The present invention provides for a large stroke piezo actuator. In one embodiment and by way of example only, the actuator device comprises a housing; a piezo actuator element disposed within the housing, a fluid region, a fluid contained within the fluid region, and an amplifier. The piezo actuator element including a long dimension and a height, wherein the long dimension is greater than the height. The fluid region is defined in the piezo actuator element at a mid-point of the long dimension and extending parallel with the height of the piezo actuator element. The fluid is contained within the fluid region. The amplifier includes a piston element, slidably coupled to the fluid region, wherein the amplifier provides a large stroke output of the piston element at a mid-point of the long dimension of the piezo actuator element in response to displacement of the fluid within the fluid region when under an influence of an applied voltage.

In another particular embodiment, and by way of example only, there is provided a piezo actuator device comprising: a housing; a first piezo element disposed within the housing; a second piezo element disposed within the housing, wherein the first piezo element and the second piezo element have a height and a combined long dimension that is greater than the height; a fluid region defined between the first piezo element and the second piezo element at a mid-point of the long dimension and extending parallel with the height of the first piezo element and the second piezo element; a fluid contained within the fluid region; and an amplifier including a piston element, slidably coupled to the fluid contained within the fluid region, the amplifier providing a large stroke output of the piston element at a mid-point of the long dimension of the first piezo element and the second piezo element in response to displacement of the fluid within the fluid region when under an influence of an applied voltage.

In yet another particular embodiment, and by way of example only, there is provided a large stroke piezo actuator device comprising: a housing; a first piezo element disposed within the housing; a second piezo element disposed within the housing, wherein the first piezo element and the second piezo element are comprised of a ceramic material having a height and a combined long dimension that is greater than the height; a fluid region defined between the first piezo element and the second piezo element at a mid-point of the long dimension and extending parallel with the height of the first piezo element and the second piezo element; a hydraulic fluid contained within the fluid region; and an amplifier including a piston element, slidably coupled to the hydraulic fluid contained within the fluid region and an opposed valve stem, the amplifier providing a large stroke output of the piston element at a mid-point of the long dimension of the first piezo element and the second piezo element in response to displacement of the hydraulic fluid within the fluid region when under an influence of an applied voltage.

Other independent features and advantages of the preferred large stroke piezo actuator will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing FIGURE, wherein:

FIG. 1 is a sectional view of a piezo actuator including a mid-point stroke output according to an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The embodiment disclosed herein is described in sufficient detail to enable those skilled in the art to practice the invention, and it is to be understood that other embodiments may be utilized and that logical, mechanical and electrical changes may be made without departing from the scope of the present invention. Furthermore, it will be understood by one of skilled in the art that although the specific embodiment illustrated below is directed at a piezo actuator typically used for actuation of a diverter valve in an aircraft, for purposes of explanation, the apparatus may be used in various other embodiments employing piezo actuators. The following detailed description is, therefore, not to be taken in a limiting sense.

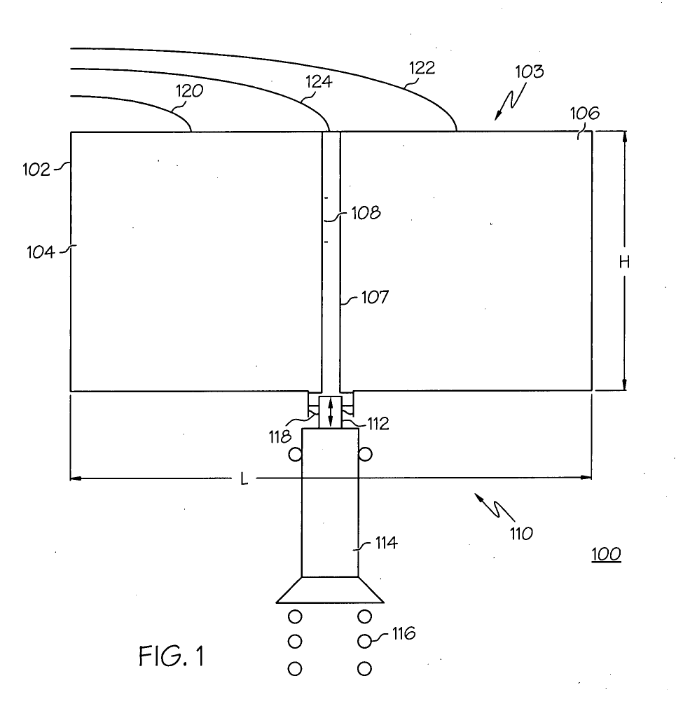

FIG. 1 is a sectional view of a piezo actuator 100, also referred to as a piezoceramic actuator, according to an embodiment. The piezo actuator 100 includes a housing 102 having housed therein a piezo actuator element 103. In contrast to previous known actuators, in the disclosed embodiment, the piezo actuator element 103 is divided into substantially equivalent halves defining a first piezo element 104 and a second piezo element 106. The first piezo element 104 and the second piezo element 106 are spaced a distance apart, thereby defining a fluid region 107 therebetween. A fluid 108 is contained or disposed within the fluid region 107. In a preferred embodiment the fluid 108 is a hydraulic fluid.

The piezo actuator 100 further includes an amplifier 110, and more particularly a hydraulic amplifier, including a piston 112 in communication with the fluid 108. Displacement of the fluid 108 is reflected in movement of the piston 112 (described presently). The piston 112 is shown having a small cross-sectional area perpendicular to its direction of motion, indicated by arrows, thus providing enhancement of a stroke output of the piezo actuator 100. As illustrated, a valve stem 114 is provided in communication with the piston 112. In a preferred embodiment, the valve stem 114 is coupled to a diverter valve body (not shown) in an aircraft, such as in a missile control system. The piston 112 is preferably biased with a spring 116 or balance piston (not shown) in the valve body. The spring 116 is configured to absorb tensile forces so that the minimum load on the first piezo element 104 and the second piezo element 106 is realized at the maximum stroke output. Furthermore, biasing of the piston 112 allows for the piston 112 to return to a beginning or neutral position.

A seal 118 is provided in communication with the piston 112 to minimize leakage of the fluid 108 from the fluid region 107 formed between the first piezo element 104 and the second piezo element 106. The minimizing of leakage of the fluid 108 provides essentially maintenance-free operation of the piezo actuator 100. The seal 118 is preferably a linear bushing or bearing having an opening through which the piston 112 passes. Alternatively, the seal 118 may be formed of an O-ring or frictional scraping device positioned to allow the piston 112 to contact the seal 118 and pass therethrough an opening during operation of the piezo actuator 100.

In one particular embodiment, the first piezo element 104 and the second piezo element 106 are generally comprised of a ceramic material having a height h and a combined long dimension l, where the long dimension l is greater than the height h. In one particular embodiment, the combined long dimension l may define a diameter of a generally overall elliptical shaped actuator. In another particular embodiment, the combined dimension l may define a length of a generally overall polygon shaped actuator. In either embodiment, it should be understood that the piezo actuator element 103 is comprised of two generally equivalent piezo elements. The fluid region 107 is defined between the first piezo element 104 and the second piezo element 108 at a mid-point of the long dimension l and extending parallel with the height of the first piezo element 104 and the second piezo element 108. The stiffness of the piezo actuator 100 depends on the Young's modulus of the ceramic material that comprises the first piezo element 104 and the second piezo element 106, the cross-sectional area and length or diameter of the ceramic material, and more specifically the first piezo element 104 and the second piezo element, and a number of other non-linear parameters.

During operation of the piezo actuator 100, a voltage is applied to each of the first piezo element 104 and the second piezo element 106 via a first electrical connection 120 and a second electrical connection 122, respectively. In turn, the first electrical connection 120 and the second electrical connection 122 are in electrical communication with a single voltage source or separate voltage sources (not shown) and configured to provide an electrical drive signal or signals. In addition, a temperature sensor connection 124 is optionally coupled to the fluid 108 and an external temperature controller (not shown) for control of the drive signal or signals based on the fluid 108 temperature. More specifically, the temperature sensor connection 124 provides for a change in the electrical bias as a function of temperature. The temperature sensor connection 124 may enable a reduction in the preload as the first piezo element 104 and the second piezo element 108 expand with heat, or an increase in the preload as the first piezo element 104 and the second piezo element 108 contracts during cooling. The voltage(s) applied to the first piezo element 104 and the second piezo element 106 produces an actuation strain which results in an expansive movement of the ceramic material that comprises the first piezo element 104 and the second piezo element 106. This expansive movement of the ceramic material, also known as piezoceramic displacement, creates a change in the pressure of the fluid 108 disposed between the first piezo element 104 and the second piezo element 106. The change in pressure of the fluid 108 in turn acts against the piston 112 to move it. The change in fluid pressure may produce a force acting against the stiffness of the piston 112 provided by the spring 116, or the fluid pressure may simply lead to a fluid displacement if the spring 116 is not biased allowing the piston 112 to move unhindered. The small piezoceramic displacement that is exerted upon the fluid 108 is amplified by the amplifier 110 and more particularly by the displaced hydraulic fluid acting on the piston 112, resulting in a large stroke output that is approximately double the stroke output of known actuators.

In this preferred embodiment, the stroke output occurs at a mid-point of the combined long dimension l of the piezo actuator 100. More specifically, the piston 112 is positioned at a mid-point of the long dimension l of the piezo actuator 100 in communication with the fluid 108. The division of the piezo element 103 into a first piezo element 104 and the second piezo element 106 provides for an increase in the stroke output. The fluid 108 amplifies the area of the first piezo element 104 and the second piezo element 106 by the stroke ratio allowing a much higher stroke amplification in the same volume as a classic piezo actuator where the stroke output is positioned at an end. In the illustrated embodiment, the spring 116 provides biasing to the stroke output, and more particularly the piston 112, so that if there are tensile loads that are not conducive to either piezo or hydraulic actuation technologies, the net load on the piezo actuator 100 is compressive. Further, the spring rate may be controlled so that the minimum load on the first piezo element 104 and the second piezo element 106 are realized at a maximum stroke output.

Accordingly, disclosed is a piezo actuator having improved performance characteristics by providing a large stroke output in a small package. To accomplish such, a piezo actuator element is provided in two halves having a fluid disposed therebetween. Each of the piezo elements is configured to expand and/or contract in the presence and/or absence of an applied electric field. A hydraulic amplifier capable of amplifying the area of the first and second piezo elements by the stroke ratio provides for a large stroke output in the middle of a long dimension of the actuator while maintaining a small overall package size.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An actuator device comprising:
a housing;
a piezo actuator element disposed within the housing and having a long dimension and a height, wherein the long dimension is greater than the height;
a fluid region defined in the piezo actuator element at a mid-point of the long dimension and extending parallel with the height of the piezo actuator element;
a fluid contained within the fluid region; and
an amplifier including a piston element, slidably coupled to the fluid region, the amplifier providing a large stroke output of the piston element at a mid-point of the long dimension of the piezo actuator element in response to displacement of the fluid within the fluid region when under an influence of an applied voltage.

2. The device of claim 1, wherein the piezo actuator element includes a first piezo element and a second piezo element, the fluid region sandwiched between the first piezo element and the second piezo element.

3. The device of claim 2, wherein the first piezo element and the second piezo element are comprised of a ceramic material that expands when under the influence of the applied voltage and contracts when not under the influence of the applied voltage.

4. The device of claim 2, wherein the first piezo element and the second piezo element each include an electrical connection to an external voltage source.

5. The device of claim 2, wherein the first piezo element includes an electrical connection to a first external voltage source and the second piezo element includes an electrical connection to a second external voltage source.

6. The device of claim 1, wherein the fluid is coupled to a temperature sensor connection and an external control source for adjusting the applied voltage based on a temperature of the fluid 108.

7. The device of claim 1, wherein the fluid is a hydraulic fluid.

8. The device of claim 1, wherein the piston element is coupled to a valve.

9. The device of claim 1, wherein the actuator device is configured for actuating a valve.

10. A piezo actuator device comprising:
a housing;
a first piezo element disposed within the housing;
a second piezo element disposed within the housing, wherein the first piezo element and the second piezo element have a height and a combined long dimension, wherein the combined long dimension is greater than the height;
a fluid region defined between the first piezo element and the second piezo element at a mid-point of the long dimension and extending parallel with the height of the first piezo element and the second piezo element;
a fluid contained within the fluid region; and
an amplifier including a piston element, slidably coupled to the fluid contained within the fluid region, the amplifier providing a large stroke output of the piston element at a mid-point of the long dimension of the first piezo element and the second piezo element in response to displacement of the fluid within the fluid region when under an influence of an applied voltage.

11. The device of claim 10, wherein the first piezo element and the second piezo element are comprised of a ceramic material that expands when under the influence of the applied voltage and contracts when not under the influence of the applied voltage.

12. The device of claim 10, wherein the first piezo element and the second piezo element each include an electrical connection to an external voltage source.

13. The device of claim 10, wherein the first piezo element includes an electrical connection to a first external voltage source and the second piezo element includes an electrical connection to a second external voltage source.

14. The device of claim 10, wherein the fluid is coupled to a temperature sensor connection and an external control source for adjusting the applied voltage based on a temperature of the fluid.

15. The device of claim 10, wherein the fluid is a hydraulic fluid.

16. The device of claim 10, wherein the piston element is coupled to a valve.

17. The device of claim 10, wherein the piezo actuator device is configured for actuating a valve.

18. A large stroke piezo actuator device comprising:
a housing;
a first piezo element disposed within the housing;
a second piezo element disposed within the housing, wherein the first piezo element and the second piezo element are comprised of a ceramic material each having a height and having a combined long dimension, wherein the combined long dimension is greater than the height;
a fluid region defined between the first piezo element and the second piezo element at a mid-point of the long dimension and extending parallel with the height of the first piezo element and the second piezo element;
a hydraulic fluid contained within the fluid region; and
an amplifier including a piston element, slidably coupled to the hydraulic fluid contained within the fluid region and an opposed valve stem, the amplifier providing a large stroke output of the piston element at a mid-point of the long dimension of the first piezo element and the second piezo element in response to displacement of the hydraulic fluid within the fluid region when under an influence of an applied voltage.

19. The device of claim 18, wherein the first piezo element and the second piezo element each include an electrical connection to an external voltage source and the hydraulic fluid is coupled to a temperature sensor connection and an external control source for adjusting the applied voltage based on a temperature of the fluid.

20. The device of claim 18, wherein the first piezo element includes an electrical connection to a first external voltage source and the second piezo element includes an electrical connection to a second external voltage source.
